(19) United States
(12) Patent Application Publication
(10) Pub. No.: US 2020/0168375 A1
(43) Pub. Date: May 28, 2020

(54) COIL COMPONENT

(71) Applicant: SAMSUNG ELECTRO-MECHANICS CO., LTD., Suwon-si, (KR)

(72) Inventors: Il Jin PARK, Suwon-si, (KR); Gwang Hwan HWANG, Suwon-si, (KR); Jun Sung LEE, Suwon-si, (KR); Soon Kwang KWON, Suwon-si, (KR)

(21) Appl. No.: 16/566,298

(22) Filed: Sep. 10, 2019

(30) Foreign Application Priority Data
Nov. 26, 2018 (KR) 10-2018-0147490

(51) Int. Cl. H01F 1/147; H01F 27/28; H01F 27/29; H01F 27/255

(52) U.S. Cl. CPC H01F 1/14766; H01F 27/2804; H01F 2027/2809; H01F 27/255; H01F 27/29

(57) ABSTRACT

A coil component includes a body having one surface and the other surface facing each other, and a plurality of wall surfaces connecting the one surface and the other surface, and having a distance from the one surface to the other surface of 0.65 mm or less (excluding 0 mm); and a coil portion embedded in the body, wherein the body comprises an Fe—Si—B—Nb—Cu-based metal magnetic powder particle represented by the following chemical formula 1, wherein the Fe—Si—B—Nb—Cu-based metal magnetic powder particle comprises a crystal grain of 20 nm or less (excluding 0 mm),

FeₐSi_{b}B_{c}Nb_{d}Cuₑ [Chemical Formula 1]
(where 73 atom %≤a≤77 atom %, 10 atom %≤b≤14 atom %, 9 atom%≤c≤11 atom %, 2 atom %≤d≤3 atom %, 0.5 atom %≤e≤1 atom %, and a+b+c+d+e=100).

### CROSS-REFERENCE TO RELATED APPLICATION(S)

This application claims benefit of priority to Korean Patent Application No. 10-2018-0147490 filed on Nov. 26, 2018 in the Korean Intellectual Property Office, the disclosure of which is incorporated herein by reference in its entirety.

### TECHNICAL FIELD

The present disclosure relates to a coil component.

### BACKGROUND

An inductor, a coil component, is a typical passive electronic component used in electronic devices, along with a resistor and a capacitor.

With higher performance and smaller sizes gradually being implemented in electronic devices, the number of coil components used in electronic devices has been increasing and becoming smaller.

For this purpose, the metal magnetic powder particle used in the manufacture of the coil component should have relatively high magnetic permeability and relatively low core loss.

### SUMMARY

An aspect of the present disclosure is to provide a coil component capable of having low-profile and excellent in terms of saturation current, inductance, magnetic permeability, and core loss value.

According to an aspect of the present disclosure, a coil component includes a body having one surface and the other surface facing each other, and a plurality of wall surfaces connecting the one surface and the other surface, and having a distance from the one surface to the other surface of 0.65 mm or less (excluding 0 mm); and a coil portion embedded in the body, wherein the body comprises an Fe—Si—B—Nb—Cu-based metal magnetic powder particle represented by the following chemical formula 1, wherein the Fe—Si—B—Nb—Cu-based metal magnetic powder particle comprises a crystal grain having a size of 20 nm or less (excluding 0 mm),

FeₐSi_{b}B_{c}Nb_{d}Cuₑ [Chemical Formula 1]

(where 73 atom %≤a≤77 atom %, 10 atom %≤b≤14 atom %, 9 atom %≤c≤11 atom %, 2 atom %≤d≤3 atom %, 0.5 atom %≤e≤1 atom %, and a+b+c+d+e=100).

### BRIEF DESCRIPTION OF DRAWINGS

The above and other aspects, features, and advantages of the present disclosure will be more clearly understood from the following detailed description, taken in conjunction with the accompanying drawings.

FIG. 1 is a schematic view illustrating a coil component according to a first embodiment of the present disclosure.

FIG. 2 is a cross-sectional view taken along line I-I′ of FIG. 1.

FIG. 3 is a cross-sectional view taken along line II-II′ of FIG. 1.

FIG. 4 is an enlarged view of portion A of FIG. 1.

FIG. 5 is an enlarged view illustrating a modified embodiment of portion A of FIG. 1.

FIG. 6 is a cross-sectional view of a spherical Fe—Si—B—Nb—Cu-based metal magnetic powder particle according to an embodiment of the present disclosure.

FIG. 7 is a cross-sectional view of a spherical Fe—Si—B—Nb—Cu-based metal magnetic powder particle illustrating a modified embodiment of FIG. 6.

FIG. 8 is a schematic view illustrating a coil component according to a second embodiment of the present disclosure.

FIG. 9 is a view illustrating the coil component of FIG. 8 taken in a downward direction.

FIG. 10 is an exploded view illustrating a coil portion.

FIG. 11 is a cross-sectional view taken along line III-III′ of FIG. 8.

### DETAILED DESCRIPTION

The terms used in the description of the present disclosure are used to describe a specific embodiment, and are not intended to limit the present disclosure. A singular term includes a plural form unless otherwise indicated. The terms “include,” “comprise,” “is configured to,” etc. of the description of the present disclosure are used to indicate the presence of features, numbers, steps, operations, elements, parts, or combination thereof, and do not exclude the possibilities of combination or addition of one or more additional features, numbers, steps, operations, elements, parts, or combination thereof. Also, the terms “disposed on,” “positioned on,” and the like, may indicate that an element is positioned on or beneath an object, and does not necessarily mean that the element is positioned above the object with reference to a gravity direction.

The term “coupled to,” “combined to,” and the like, may not only indicate that elements are directly and physically in contact with each other, but also include the configuration in which another element is interposed between the elements such that the elements are also in contact with the other component.

Sizes and thicknesses of elements illustrated in the drawings are indicated as examples for ease of description, and the present disclosure are not limited thereto.

In the drawings, an L direction is a first direction or a length (longitudinal) direction, a W direction is a second direction or a width direction, a T direction is a third direction or a thickness direction.

Hereinafter, a coil component according to an embodiment of the present disclosure will be described in detail with reference to the accompanying drawings. Referring to the accompanying drawings, the same or corresponding components may be denoted by the same reference numerals, and overlapped descriptions will be omitted.

In electronic devices, various types of electronic components may be used, and various types of coil components may be used between the electronic components to remove noise, or for other purposes.

In other words, in electronic devices, a coil component may be used as a power inductor, a high frequency (HF) inductor, a general bead, a high frequency (GHz) bead, a common mode filter, and the like.

### First Embodiment

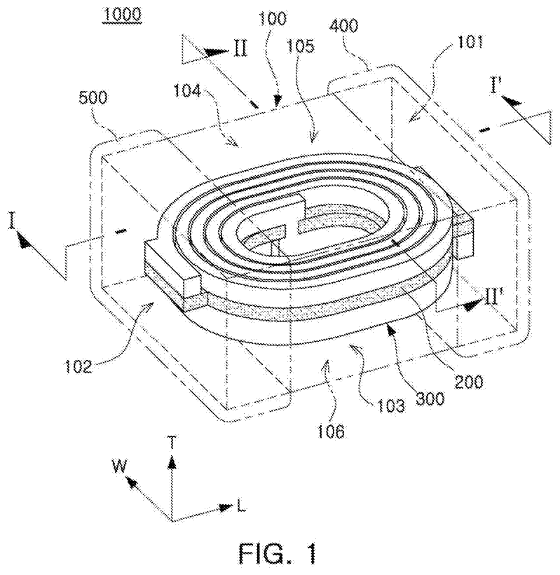

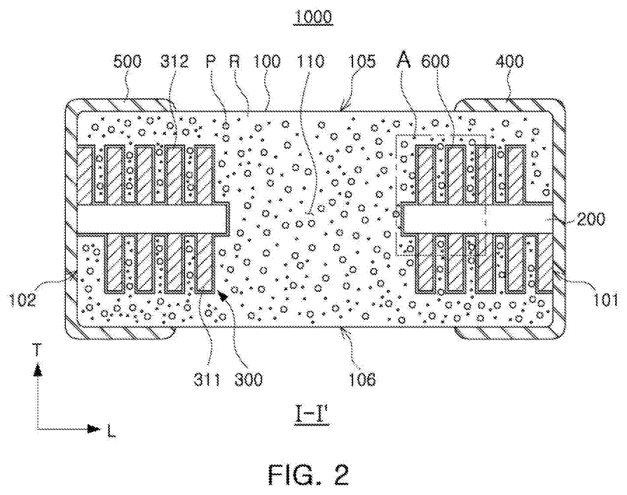

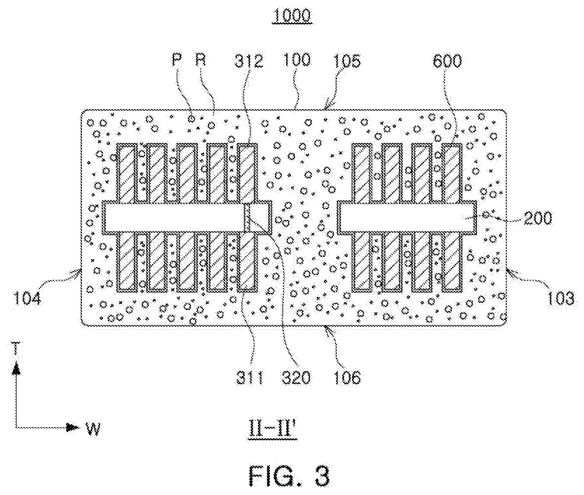

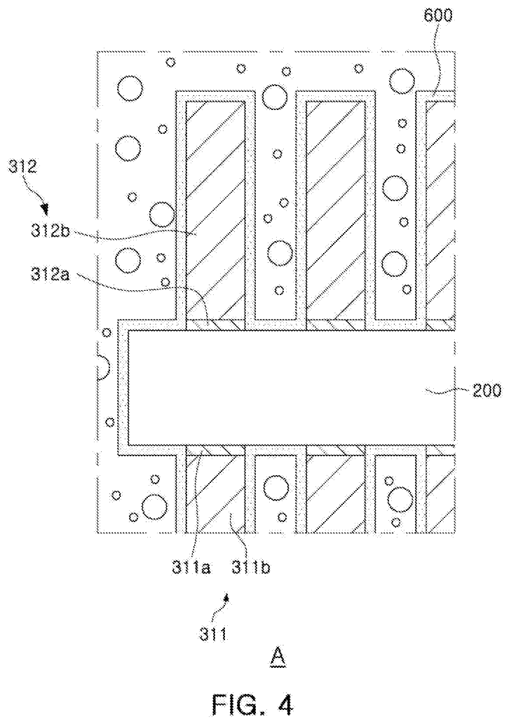

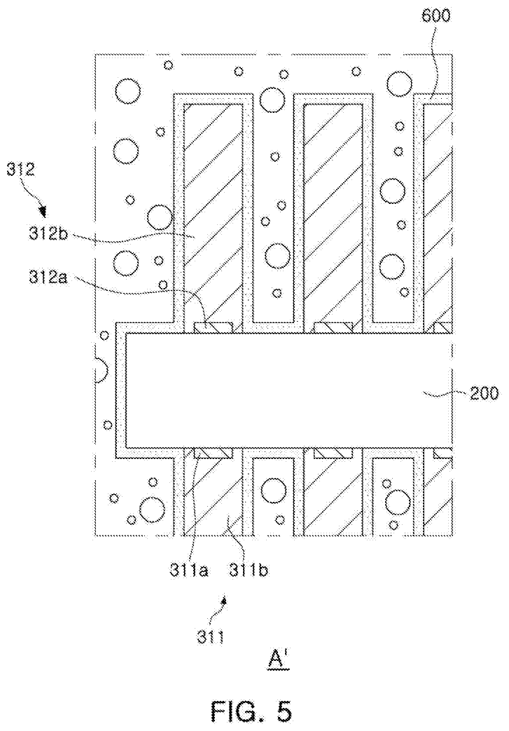

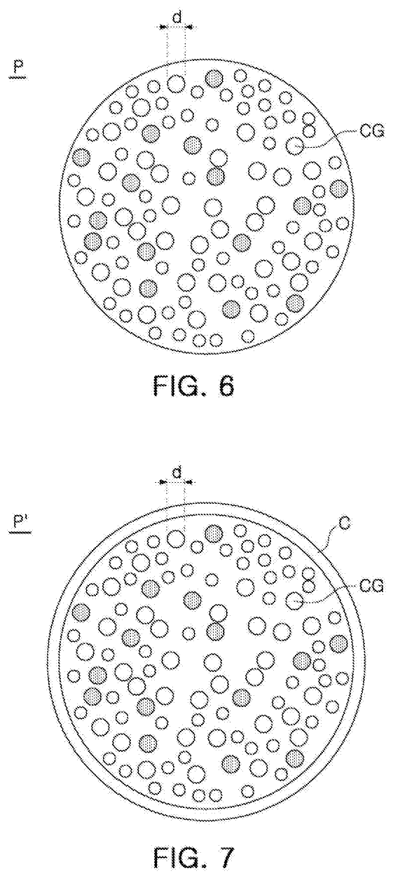

FIG. 1 is a schematic view illustrating a coil component according to a first embodiment of the present disclosure. FIG. 2 is a cross-sectional view taken along line I-I′ of FIG. 1. FIG. 3 is a cross-sectional view taken along line II-II′ of FIG. 1. FIG. 4 is an enlarged view of portion A of FIG. 1. FIG. 5 is an enlarged view illustrating a modified embodiment of portion A of FIG. 1. FIG. 6 is a cross-sectional view of a spherical Fe—Si—B—Nb—Cu-based metal magnetic powder particle according to an embodiment of the present disclosure. FIG. 7 is a cross-sectional view of spherical Fe—Si—B—Nb—Cu-based metal magnetic powder particle illustrating a modified embodiment of FIG. 6.

Referring to FIGS. 1 to 7, a coil component 1000 according to an embodiment of the present disclosure may include a body 100, an insulating substrate 200, a coil portion 300, and external electrodes 400 and 500, and may further include an insulating film 600.

The body 100 may form an exterior of the coil component 1000 according to this embodiment, and the insulating substrate 200 and the coil portion 300 may be embedded therein.

The body 100 may be formed to have a hexahedral shape overall.

Based on the directions of FIGS. 1 to 3, the body 100 may include a first surface 101 and a second surface 102 facing each other in a longitudinal direction L, a third surface 103 and a fourth surface 104 facing each other in a width direction W, and a fifth surface 105 and a sixth surface 106 facing each other in a thickness direction T. Each of the first to fourth surfaces 101, 102, 103, and 104 of the body 100 may correspond to wall surfaces of the body 100 connecting the fifth surface 105 and the sixth surface 106 of the body 100. Hereinafter, both end surfaces of the body 100 may refer to the first surface 101 and the second surface 102 of the body 100, both side surfaces of the body 100 may refer to the third surface 103 and the fourth surface 104 of the body 100, one surface of the body 100 may refer to the sixth surface 106 of the body 100, and the other surface of the body 100 may refer to the fifth surface 105 of the body 100. Further, hereinafter, an upper surface and a lower surface of the body 100 may refer to the fifth surface 105 and the sixth surface 106 of the body 100, respectively, based on the directions of FIGS. 1 to 3.

The body 100 may be formed such that the coil component 1000 according to this embodiment in which the external electrodes 400 and 500 to be described later are formed has a length of 2.0 mm, a width of 1.2 mm, and a thickness of 0.65 mm, but is not limited thereto. Alternatively, the body 100 may be formed such that the coil component 1000 according to this embodiment in which the external electrodes 400 and 500 to be described later are formed has a length of 2.0 mm, a width of 1.6 mm, and a thickness of 0.55 mm. Alternatively, the body 100 may be formed such that the coil component 1000 according to this embodiment in which the external electrodes 400 and 500 to be described later are formed has a length of 2.0 mm, a width of 1.2 mm, and a thickness of 0.55 mm. Alternatively, the body 100 may be formed such that the coil component 1000 according to this embodiment in which the external electrodes 400 and 500 to be described later are formed has a length of 1.2 mm, a width of 1.0 mm, and a thickness of 0.55 mm. Since the above-described sizes of the coil component 1000 according to this embodiment are merely illustrative, cases in which sizes are smaller than the above-mentioned sizes may be not excluded from the scope of the present disclosure.

The body 100 may include a metal magnetic powder particle (P) and an insulating resin (R). Specifically, the body 100 may be formed by stacking at least one magnetic composite sheet including the insulating resin (R) and the metal magnetic powder particle (P) dispersed in the insulating resin (R), and then curing the magnetic composite sheet.

The metal magnetic powder particle (P) may include one or more selected from the group consisting of iron (Fe), silicon (Si), chromium (Cr), cobalt (Co), molybdenum (Mo), aluminum (Al), niobium (Nb), copper (Cu), boron (B), and nickel (Ni). For example, the metal magnetic powder particle (P) may be an Fe—Si—B—Nb—Cu-based alloy powder including Fe, Si, B, Nb and Cu. The Fe—Si—B—Nb—Cu-based alloy powder may be a Fe—Si—B—Nb—Cu-based metal magnetic powder particle (P).

Referring to FIG. 6, the Fe—Si—B—Nb—Cu-based metal magnetic powder particle (P) applied to this embodiment may have a crystal grain (CG) having a size (d) of 10 nm or more and 20 nm or less, formed therein. When the crystal grain (CG) having a nanoscale size is formed in the Fe—Si—B—Nb—Cu-based metal magnetic powder particle (P), in a subsequent process, crystallization of structure is inhibited due to the crystal grain (CG) already present in the metal magnetic powder particle (P), and the stability thereof against heat may be excellent. The Fe—Si—B—Nb—Cu-based metal magnetic powder particle (P) containing the crystal grain (CG) may exhibit a relatively high magnetic permeability as compared with amorphous metal magnetic powder particles of the Fe—Si—B—Nb—Cu-based metal magnetic powder particle (P), which does not include the crystal grain (CG). Since the Fe—Si—B—Nb—Cu-based metal magnetic powder particle (P) of the present disclosure contains the crystal grain (CG) having a size of 20 nm or less, the crystal magnetic anisotropy may be close to zero (0). Therefore, the Fe—Si—B—Nb—Cu-based metal magnetic powder particle (P) containing the crystal grain (CG) may achieve a lower core loss than the amorphous metal magnetic powder particles of the Fe—Si—B—Nb—Cu-based metal magnetic powder particle (P).

The crystal grain (CG) may include iron silicide (Fe₃Si). The crystal grain (CG) of iron silicide (Fe₃Si) may be formed in the metal magnetic powder particle (P) during a heat treatment of quenched magnetic powder particles of the Fe—Si—B—Nb—Cu-based alloy, in a case of a method for producing the Fe—Si—B—Nb—Cu-based metal magnetic powder particle (P), which will be described later.

The Fe—Si—B—Nb—Cu-based metal magnetic powder particle (P) to be used in this embodiment may be represented by the following chemical formula 1, and, in the chemical formula 1, 73 atom %≤a≤77 atom %, 10 atom %≤b≤14 atom %, 9 atom %≤c 11 atom %, 2 atom %≤d≤3 atom %, 0.5 atom %≤e≤1 atom %, and a+b+c+d+e=100 may be satisfied. The atom percent (atom %) is an absolute number of the atom in 100 atoms of the Fe, Si, B, Nb and B.

FeₐSi_{b}B_{c}Nb_{d}Cuₑ [Chemical Formula 1]

In this case, the magnetic permeability of the Fe—Si—B—Nb—Cu-based metal magnetic powder particle (P) may be changed depending on a composition ratio of each element (i.e., Fe, Si, B, Nb and Cu), and the inductance of the coil component may be controlled depending on the change of the magnetic permeability.

The Fe—Si—B—Nb—Cu-based metal magnetic powder particle (P) applied to this embodiment may be formed to have a spherical shape. The spherical Fe—Si—B—Nb—Cu-based metal magnetic powder particle (P) applied to this embodiment may be formed to have an average particle diameter of 10 μm or more and 50 μm or less, and may increase packing factor due to the spherical shape in manufacturing a coil component such as power inductor, or the like. Due to this increased packing factor, the coil component according to this embodiment may have a relatively high magnetic permeability. In the present specification, the average particle diameter of the metal magnetic powder particle (P) means an average particle diameter according to the particle size distribution of D₅₀ or D₉₀. In one embodiment, the spherical Fe—Si—B—Nb—Cu-based metal magnetic powder (P) may have 10 μm or more and 50 μm or less of an average particle diameter of D50.

Wardell's sphericity (Ψ) is known as an index to determine whether a particle shape is close to a sphere. Wardell's sphericity (Ψ) may be a ratio of a surface area of an actual particle and a surface area of a sphere, having the same volume as those of the actual particle, and may be defined by the following Equation 1.

Ψ=(Surface Area of Sphere having the same volume as those of Actual Particle)/(Surface Area of Actual Particle) [Equation 1]

Generally, in a particle having a certain volume, a surface area of a particle having a spherical shape may be the smallest. Wardell's sphericity (Ψ) may have a numerical value of 1 or less in a conventional particle, and may be converged to 1 in a particle having a perfect spherical shape.

The spherical Fe—Si—B—Nb—Cu-based metal magnetic powder particle (P) applied to this embodiment may have Wardell's sphericity (Ψ) of 0.8 or more and 1.0 or less.

When the spherical Fe—Si—B—Nb—Cu-based metal magnetic powder particle (P) applied to this embodiment is less than 0.8 based on Wadell's sphericity, the effect of improving the filling factor of the metal powder particle may be insignificant.

In view of the definition of Wadell's sphericity (Ψ), there may be no spherical powder particle having a sphericity exceeding 1.0.

The Fe—Si—B—Nb—Cu-based metal magnetic powder particle (P) applied to this embodiment may be produced by an operation of preparing a Fe—Si—B—Nb—Cu-based alloy material, an operation of melting the alloy material, an operation of gas atomizing the molten alloy material to prepare a Fe—Si—B—Nb—Cu-based metal magnetic powder particle having a spherical shape, and an operation of heat treating the Fe—Si—B—Nb—Cu-based metal magnetic powder particle to form a crystal grain having a nanoscale size.

In the operation of preparing the Fe—Si—B—Nb—Cu-based alloy material, the Fe—Si—B—Nb—Cu-based alloy material may be prepared in an ingot form, but is not limited thereto.

In the operation of melting the alloy material, the alloy material may be melted by heating at a temperature of 1,250° C. or higher, which may be a temperature higher than the melting point of the Fe—Si—B—Nb—Cu-based alloy material, but the heating temperature may be applied up to 1,600° C., as needed.

In the operation of gas atomizing the molten alloy material to prepare a Fe—Si—B—Nb—Cu-based metal magnetic powder particle having a spherical shape, the molten alloy material may be dropped into water flowing in a droplet state, and may be quenched to form the metal magnetic powder particle having a spherical shape.

An apparatus for the operation of gas atomizing may include a storage tank for containing the molten Fe—Si—B—Nb—Cu-based alloy material, a water tank for receiving droplets of the molten alloy material falling from the storage tank, a nozzle for blowing an inert gas when the water in the water tank, for example, the molten droplet falls, and a recovery unit for recovering a metal magnetic powder particle, having a spherical shape, formed in the water tank.

In the operation of heat treating the Fe—Si—B—Nb—Cu-based metal magnetic powder particle to form a crystal grain having a nanoscale size, the Fe—Si—B—Nb—Cu-based metal magnetic powder particle having a spherical shape may be heat treated at a temperature of 520° C. to 560° C. for 30 to 90 minutes to form a crystal grain having a nanoscale size in the metal magnetic powder particle having a spherical shape.

In this case, temperature and time for the operation of the heat treating may be controlled by a particle size of the Fe—Si—B—Nb—Cu-based metal magnetic powder particle and the like.

Referring to FIG. 7, a Fe—Si—B—Nb—Cu-based metal magnetic powder particle (P′) applied to this modified embodiment may further include an insulating coating layer (C) surrounding a surface of a metal magnetic powder particle. The insulating coating layer (C) may include an epoxy resin or a polyimide resin as an electrically insulating resin, but is not limited thereto. In one embodiment, the insulating coating layer (C) may be formed of a material different from a material included in an insulating resin (R).

The body 100 may include two or more types of metal magnetic powder particles dispersed in the insulating resin (R). When the body 100 includes two or more types of metal magnetic powder particle, the body 100 may include at least the Fe—Si—B—Nb—Cu-based metal magnetic powder particle (P) of the present embodiment. In this case, the term “different types of metal magnetic powder particle” means that the metal magnetic powder particles dispersed in the insulating resin (R) may be distinguished from each other by a diameter, a composition, crystallinity, and a shape. For example, the body 100 may comprise two or more metal magnetic powder particles of different diameters.

The insulating resin (R) may include an epoxy, a polyimide, a liquid crystal polymer, or the like, in a single form or in combined form, but is not limited thereto.

The body 100 may include a core 110 passing through the coil portion 300, which will be described later. The core 110 may be formed by filling through holes of the coil portion 300 with a magnetic composite sheet, in operations of stacking and curing the magnetic composite sheet, but is not limited thereto. The magnetic composite sheet may include the insulating resin (R) and Fe—Si—B—Nb—Cu-based metal magnetic powder particle (P) dispersed in the insulating resin (R).

The insulating substrate 200 may be embedded in the body 100. The insulating substrate 200 may be configured to support the coil portion 300, which will be described later.

The insulating substrate 200 may be formed of an insulating material including a thermosetting insulating resin, such as an epoxy resin, polyimide, or a photosensitive insulating resin, or may be formed of an insulating material in which a reinforcing material such as a glass fiber or an inorganic filler is impregnated with such as an insulating resin. For example, the insulating substrate 200 may be formed of an insulating material such as prepreg, Ajinomoto Build-up Film (ABF), FR-4, a bismaleimide triazine (BT) resin, a photoimageable dielectric (PID), and the like, but are not limited thereto.

As the inorganic filler, at least one or more selected from a group consisting of silica (SiO₂), alumina (Al₂O₃), silicon carbide (SiC), barium sulfate (BaSO₄), talc, mud, a mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

When the insulating substrate 200 is formed of an insulating material including a reinforcing material, the insulating substrate 200 may provide better rigidity. When the insulating substrate 200 is formed of an insulating material not containing glass fibers, the insulating substrate 200 may be advantageous for reducing a thickness of the overall coil portion 300. When the insulating substrate 200 is formed of an insulating material containing a photosensitive insulating resin, the number of processes for forming the coil portion 300 may be reduced. Therefore, it may be advantageous in reducing production costs, and a via may be formed more finely.

The coil portion 300 may include first and second coil patterns 311 and 312, having a planar spiral shape, arranged on the insulating substrate 200, and may be embedded in the body 100, to manifest the characteristics of the coil component. For example, when the coil component 1000 of this embodiment is used as a power inductor, the coil portion 300 may function to stabilize the power supply of an electronic device by storing an electric field as a magnetic field and maintaining an output voltage.

The coil portion 300 may include the coil patterns 311 and 312, and a via 320. Specifically, based on the directions of FIGS. 1, 2, and 3, a first coil pattern 311 may be disposed on a lower surface of the insulating substrate 200 facing the sixth surface 106 of the body 100, and a second coil pattern 312 may be disposed on an upper surface of the insulating substrate 200. The via 320 may pass through the insulating substrate 200, and may be in contact with and connected to the first coil pattern 311 and the second coil pattern 312, respectively. In this configuration, the coil portion 300 may function as a single coil which forms one or more turns about the core 110 overall.

Each of the first coil pattern 311 and the second coil pattern 312 may be in a planar spiral shape having at least one turn formed around the core 110. For example, based on the direction of FIG. 2, the first coil pattern 311 may form at least one turn around the core 110 on the lower surface of the insulating substrate 200.

End portions of the first and second coil patterns 311 and 312 may be connected to the first and second external electrodes 400 and 500, respectively, which will be described later. For example, the end portion of the first coil pattern 311 may be connected to the first external electrode 400, and the end portion of the second coil pattern 312 may be connected to the second external electrode 500.

For example, the end portion of the first coil pattern 311 may be exposed on the first surface 101 of the body 100, and the end portion of the second coil pattern 312 may be exposed on the second surface 102 of the body 100, to be in contact with and connected to the first and second external electrodes 400 and 500 disposed on the first and second surfaces 101 and 102 of the body 100, respectively.

Each of the first and second coil patterns 311 and 312 may include first conductive layers 311a and 312a formed to contact the insulating substrate 200, respectively, and second conductive layers 311b and 312b disposed on the first conductive layers 311a and 312a, respectively. Based on the directions of FIGS. 4 and 5, the first coil pattern 311 may include a first conductive layer 311a formed to contact the lower surface of the insulating substrate 200, and a second conductive layer 311b disposed on the first conductive layer 311a. Based on the directions of FIGS. 4 and 5, the second coil pattern 312 may include a first conductive layer 312a formed to contact the upper surface of the insulating substrate 200, and a second conductive layer 312b disposed on the first conductive layer 312a.

The first conductive layers 311a and 312a may be seed layers for forming the second conductive layers 311b and 312b by an electrolytic plating process. The first conductive layers 311a and 312a, which may be seed layers of the second conductive layers 311b and 312b, may be formed to be thinner than the second conductive layers 311b and 312b. The first conductive layers 311a and 312a may be formed by a thin film process such as sputtering or an electroless plating process. When the first conductive layers 311a and 312a are formed by a thin film process such as sputtering, at least a portion of materials constituting the first conductive layers 311a and 312a may be passed through the insulating substrate 200. It can be confirmed that a concentration of a metal material constituting the first conductive layers 311a and 312a in the insulating substrate 200 varies in the thickness direction T of the body 100.

A thickness of the first conductive layers 311a and 312a may be 1.5 μm or more and 3 μm or less. When the thickness of the first conductive layers 311a and 312a is less than 1.5 μm, it may be difficult to exhibit their functions as the first conductive layers 311a and 312a. When the thickness of the first conductive layers 311a and 312a is more than 3 μm, it may be difficult to form the second conductive layers 311b and 312b because a volume of the body 100 is limited, and a volume of the first conductive layers 311a and 312a may become relatively large within the limited volume of the body 100.

Referring to FIG. 4, the second conductive layers 311b and 312b may expose at least a portion of the side surfaces of the first conductive layers 311a and 312a. Thus, the second conductive layers 311b and 312b may not be formed at least a portion of the side surfaces of the first conductive layers 311a and 312a. In this embodiment, a seed film for forming the first conductive layers 311a and 312a may be formed on the entirety of both side surfaces of the insulating substrate 200, a plating resist for forming the second conductive layers 311b and 312b may be formed on the seed film, the second conductive layers 311b and 312b may be formed by the electrolytic plating process, the plating resist may be removed, and the seed film on which the second conductive layers 311b and 312b are not formed may be selectively removed, to form the first conductive layers 311a and 312a, and the second conductive layers 311b and 312b. Therefore, at least a portion of the side surfaces of the first conductive layers 311a and 312a formed by selectively removing the seed film may be exposed without being covered by the second conductive layers 311b and 312b. The seed film may be formed by performing an electroless plating process or a sputtering process on the insulating substrate 200. Alternatively, the seed film may be a copper foil of a copper clad laminate (CCL). The plating resist may be formed by applying a material for forming the plating resist to the seed film and then performing a photolithography process thereon. After performing the photolithography process, an opening may be formed in a region in which the second conductive layers 311b and 312b are to be formed. The selective removal of the seed film may be performed by a laser process and/or an etching process. In the case in which the seed film is selectively removed by etching, the first conductive layers 311a and 312a may be formed in such a manner that the cross-sectional area thereof increases as the side surfaces thereof proceed from the second conductive layers 311b and 312b toward the insulating substrate 200.

Referring to FIG. 5, the second conductive layers 311b and 312b may cover the first conductive layers 311a and 312a, respectively. In a different manner to FIG. 4, the first conductive layers 311a and 312a patterned in a plane spiral shape may be respectively formed on both side surfaces of the insulating substrate 200, and the second conductive layers 311b and 312b may be formed on the first conductive layers 311a and 312a, respectively, by an electrolytic plating process. When the second conductive layers 311b and 312b are formed by an anisotropic plating process, a plating resist may not be used, but is not limited thereto. For example, when the second conductive layers 311b and 312b are formed, a plating resist for forming the second conductive layer may be used. An opening for exposing the first conductive layers 311a and 312a, which is an area where the first conductive layers 311a and 312a are not disposed on the insulating substrate, may be formed in the plating resist for forming the second conductive layer. A diameter of the opening may be larger than a line width of the first conductive layers 311a and 312a. Therefore, the second conductive layers 311b and 312b filling the opening may cover the side surfaces of the first conductive layers 311a and 312a.

The via 320 may include at least one conductive layer. For example, when the via 320 is formed by an electrolytic plating process, the via 320 may include a seed layer formed on an inner wall of a via hole passing through the insulating substrate 200, and an electrolytic plating layer filling the via hole formed with the seed layer. The seed layer of the via 320 may be formed integrally with the first conductive layers 311a and 312a in the same process as the first conductive layers 311a and 312a, or may form a boundary between the seed layer and each of the first conductive layers 311a and 312a in a process different from the first conductive layers 311a and 312a. In the case of this embodiment, the seed layer of the via 320 and the first conductive layers 311a and 312a may be formed in different processes to form a boundary therebetween.

When the line widths of the coil patterns 311 and 312 are excessively wide, a volume of the magnetic body in the body 100 may be reduced to adversely affect inductance. In a non-limiting example, an aspect ratio (AR) of the coil patterns 311 and 312 may be between 3:1 and 9:1.

Each of the coil patterns 311 and 312 and the via 320 may be formed of a conductive material such as copper (Cu), aluminum (Al), silver (Ag), tin (Sn), gold (Au), nickel (Ni), lead (Pb), titanium (Ti), chromium (Cr), or alloys thereof, but are not limited thereto. As a non-limiting example, when the first conductive layers 311a and 312a are formed in a sputtering process, and the second conductive layers 311b and 312b are formed by an electrolytic plating process, the first conductive layers 311a and 312a may include at least one of molybdenum (Mo), chromium (Cr), and titanium (Ti), and the second conductive layers 311b and 312b may include copper (Cu). As another non-limiting example, when the first conductive layers 311a and 312a are formed by an electroless plating process, and the second conductive layers 311b and 312b are formed by an electrolytic plating process, the first conductive layers 311a and 312a, and the second conductive layers 311b and 312b may include copper (Cu). In this case, a density of copper (Cu) in the first conductive layers 311a and 312a may be lower than a density of copper (Cu) in the second conductive layers 311b and 312b.

The external electrodes 400 and 500 may be disposed on surfaces of the body 100, and may be connected to both end portions of the coil portion 300, respectively. In this embodiment, both end portions of the coil portion 300 may be exposed on the first and second surfaces 101 and 102 of the body 100, respectively. The first external electrode 400 may be disposed on the first surface 101 and may be in contact with and connect to an end portion of the first coil pattern 311 exposed on the first surface 101 of the body 100, and the second external electrode 500 may be disposed on the second surface 102 and may be in contact with and connect to an end portion of the second coil pattern 312 exposed on the second surface 102 of the body 100.

The external electrodes 400 and 500 may be formed of a conductive material such as copper (Cu), aluminum (Al), silver (Ag), tin (Sn), gold (Au), nickel (Ni), lead (Pb), titanium (Ti), or alloys thereof, but is not limited thereto.

The external electrodes 400 and 500 may have a single-layer structure or a multilayer structure. For example, the first external electrode 400 may include a first layer comprising copper, a second layer disposed on the first layer and comprising nickel (Ni), and a third layer disposed on the second layer and comprising tin (Sn). The first to third surfaces may be formed by an electrolytic plating process, but are not limited thereto. As another example, the first external electrode 400 may include a resin electrode including a conductive powder particle and a resin, and a plating layer formed on the resin electrode by a plating process. In this case, the resin electrode layer may include a conductive powder particle of at least one of copper (Cu) or silver (Ag), or a cured product of a thermosetting resin. Further, the plating layer may include a first plating layer including nickel (Ni), and a second plating layer including tin (Sn).

The insulating film 600 may be formed on the insulating substrate 200 and the coil portion 300. The insulating film 600 may be for insulating the coil portion 300 from the body 100, and may include a known insulating material such as parylene, and the like. An insulating material included in the insulating film 600 may be any material, and is not particularly limited thereto. The insulating film 600 may be formed using a vapor deposition process or the like, but is not limited thereto, and may be formed using stacking an insulation film on both surfaces of the insulating substrate 200. In the former case, the insulating film 600 may be formed in the form of a conformal film along the surfaces of the insulating substrate 200 and the coil portion 300. In the latter case, the insulating film 600 may be formed to fill a space between neighboring turns of the coil patterns 311 and 312. As described above, a plating resist may be formed on the insulating substrate 200 for forming the second conductive layers 311b and 312b, and such a plating resist may be a permanent resist which may be not removed. In this case, the insulating film 600 may be a plating resist which may be a permanent resist. The insulating film 600 may be omitted, when the body 100 secures sufficient insulation resistance under operating conditions of the coil component 1000 according to this embodiment.

### EXPERIMENTAL EXAMPLE 1

An alloy material having a composition of Fe_{73.5}Si_{13.5}B₉Nb₃Cu₁ was melted, a gas atomizing process was carried out on the melted alloy material, to prepare a metal magnetic powder particle (P) having a spherical shape, and then the metal magnetic powder particle (P) was heat treated at 525° C. for 30 minutes, to form a crystal grain (CG), having a nanoscale size of 10 nm or more and 20 nm or less, in the metal magnetic powder particle (P).

The spherical Fe—Si—B—Nb—Cu-based metal magnetic powder particle formed with a crystal grain (CG) having a nanoscale size, was dispersed in an epoxy resin to prepare magnetic composite sheets.

Next, a coil portion including first and second coil patterns was formed on an insulating substrate by a thin film process.

The magnetic composite sheets are stacked on both surfaces of an insulating substrate on which the coil portion has been formed, to form a body having a thickness of 0.60 mm.

### EXPERIMENTAL EXAMPLE 2

An alloy material having a composition of Fe_{7.35}Si_{13.5}B₉Nb₃Cu₁ was melted, and a gas atomizing process was carried out on the melted alloy material, to prepare a metal magnetic powder particle having a spherical shape. The heat treatment of the metal magnetic powder particle was not conducted.

The spherical Fe—Si—B—Nb—Cu-based metal magnetic powder particle was dispersed in an epoxy resin to prepare magnetic composite sheets.

Next, a coil portion including first and second coil patterns was formed on an insulating substrate by a thin film process.

The magnetic composite sheets are stacked on both surfaces of an insulating substrate on which the coil portion has been formed, to form a body having a thickness of 0.6 mm.

In Experimental Examples 1 and 2, the number of turns, a thickness of a coil pattern, a line width of a coil pattern, and a pitch of a coil pattern are all made the same.

In the body formed by Experimental Examples 1 and 2, inductance and magnetic permeability are measured by an impedance analyzer, and core loss was measured by a B—H analyzer.

Experimental frequency was 3 MHz.

TABLE 1

| Ex. | Inductance | Magnetic Permeability | Core Loss |
|---|---|---|---|
| # 1 | 0.56 uH | 36 | 70 mW/cc |
| # 2 | 0.48 uH | 31 | 180 mW/cc |

Referring to Table 1, it can be seen that, in the case of the coil component of Experimental Example 1 using the spherical Fe—Si—B—Nb—Cu-based metal magnetic powder particle having nanocrystal grains formed therein, the inductance and the magnetic permeability were higher, and the core loss was lower than the coil component of Experimental Example 2 using the spherical Fe—Si—B—Nb—Cu-based metal magnetic powder particle, which does not have nanocrystal grains.

Each of these Experimental Examples was a thin film coil component, but this is merely for convenience of explanation. Therefore, the Fe—Si—B—Nb—Cu-based metal magnetic powder particle (P) having nanocrystal grains formed therein may be used not only for forming the thin film type coil component but also for forming the magnetic core and/or the body for coil type coil component.

As the coil component was thinned, the total volume of the magnetic body in the coil component may be inevitably reduced, such that it may be difficult to implement capacity. In order to solve this problem, although it is possible to increase the size of the magnetic powder particle in the coil component, in this case, the eddy current may increase as the size of the magnetic powder particle increases.

In Experimental Example 1, the body 100 includes the Fe—Si—B—Nb—Cu-based metal magnetic powder particle (P) having nanocrystal grains (CG) formed therein. Even though the thickness of the body 100 was reduced, the capacity of the coil component 1000 was secured. Since the Fe—Si—B—Nb—Cu-based metal magnetic powder particle (P) applied in this embodiment had the nanocrystal grains (CG) formed therein, the capacity was secured without increasing the size, comparing to those of the conventional metal magnetic powder particle such as the one of Experimental Example 2. As a result, the core loss due to eddy currents and the like may be reduced.

### EXPERIMENTAL EXAMPLES 3 TO 9

The following Table 2 illustrates a filling rate, inductance, magnetic permeability, and core loss of a metal magnetic powder particle, depending on a particle diameter of the metal magnetic powder particle and a thickness of a body.

In Experimental Examples 3 to 9, spherical metal magnetic powder particles were formed under the same conditions as Experimental Example 1, but an average particle diameter (D₅₀) of the metal magnetic powder particle and a thickness of a body were changed.

In Experimental Examples 3 to 9, coil portions were prepared such that the number of turns, a thickness of a coil pattern, a line width of a coil pattern, and a pitch of the coil pattern were all the same.

For bodies prepared by Experimental Examples 3 to 9, inductance and magnetic permeability were measured by an impedance analyzer, and core loss was measured by a B—H analyzer.

Experimental frequency was 3 MHz.

TABLE 2

| | | Metal | | | | |
|---|---|---|---|---|---|---|
| | | Magnetic | | | | |
| | | Powder | | | | |
| | Thick- | Particle | | | Magnetic | |
| Body | ness | Diameter | Filling | | Permea- | |
| Ex. | (mm) | (μm, D₅₀) | Rate | Inductance | bility | Core Loss |
| # 3 | 0.60 | 9 | 78% | 0.7 uH | 26 | 130 mW/cc |
| # 4 | 0.60 | 10 | 80% | 0.8 uH | 28 | 150 mW/cc |
| # 5 | 0.60 | 15 | 83% | 0.9 uH | 32 | 200 mW/cc |
| # 6 | 0.60 | 18 | 84% | 0.95 uH | 33 | 220 mW/cc |
| # 7 | 0.60 | 20 | 85% | 1.0 uH | 35 | 240 mW/cc |
| # 8 | 0.80 | 10 | 80% | 0.9 uH | 28 | 150 mW/cc |
| # 9 | 0.80 | 15 | 83% | 1.0 uH | 32 | 200 mW/cc |

Referring to Table 2, in each of Experimental Examples 4 to 6, the body thickness was 0.60 mm, which was 0.65 mm or less, and the average particle diameter of the metal magnetic powder particle (D₅₀) was 10 μm, 15 μm, and 18 μm, respectively.

Each of Experimental Examples 4 to 6 improves the filling rate, the inductance, and the magnetic permeability, as compared with Experimental Example 3. Further, in each of Experimental Examples 4 to 6, the core loss was reduced, as compared with Experimental Example 7, and the thickness of the body was made thinner than Experimental Examples 8 and 9.

Each of Experimental Examples 4 to 6 improved the filling rate, the inductance, the magnetic permeability, and the core loss characteristics, while reducing the thickness of the body, compared with Experimental Examples 3 and 7 to 9.

### Second Embodiment

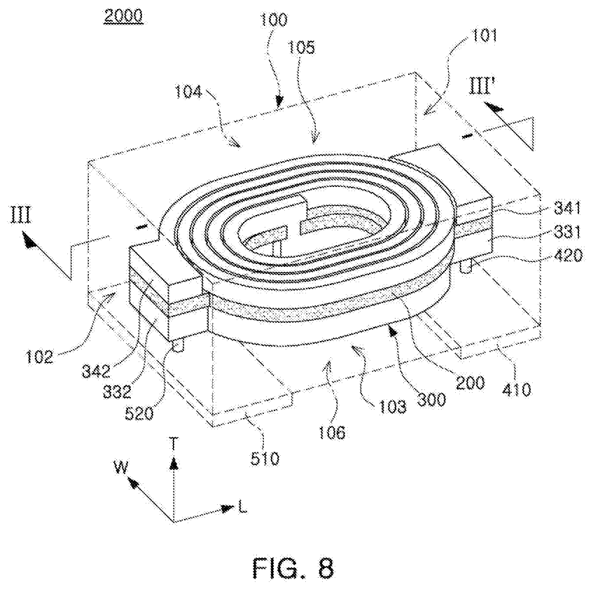

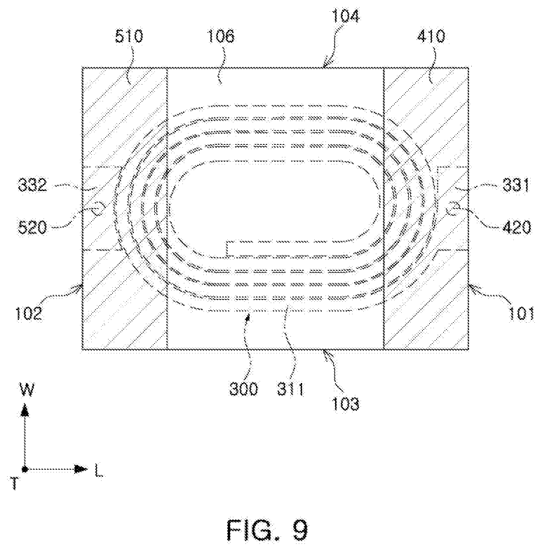

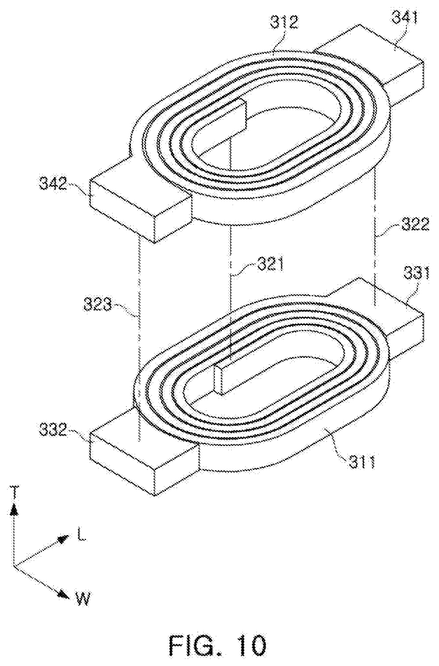

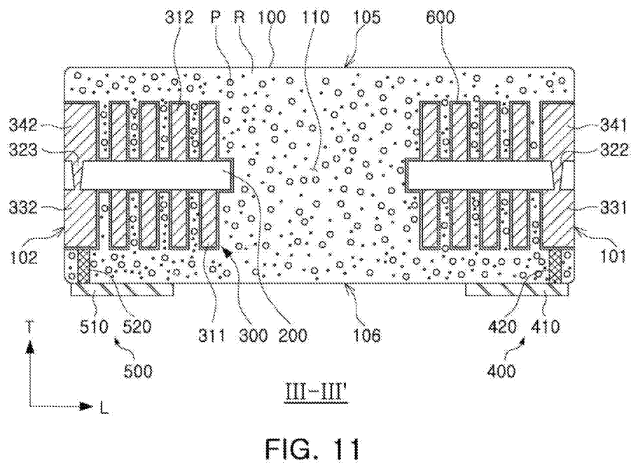

FIG. 8 is a schematic view illustrating a coil component according to a second embodiment of the present disclosure. FIG. 9 is a view illustrating the coil component of FIG. 8 taken in a downward direction. FIG. 10 is an exploded view illustrating a coil portion. FIG. 11 is a cross-sectional view taken along line of FIG. 8.

Referring to FIGS. 1 to 11, a coil component 2000 according to the second embodiment may be different from the coil component 1000 according to the first embodiment of the present disclosure, in view of a coil portion 300 and external electrodes 400 and 500. Therefore, in describing the second embodiment, only the coil portion 300 and the external electrodes 400 and 500 different from the first embodiment will be described. The description of the first embodiment of the present disclosure may be applied to the remaining configuration of the second embodiment, as it is or in a modified manner.

A coil portion 300 applied to the second embodiment may include coil patterns 311 and 312, lead-out patterns 331 and 332, auxiliary lead-out patterns 341 and 342, and vias 321, 322, and 323.

In particular, based on the directions of FIGS. 8, 10, and 11, a first coil pattern 311, a first lead-out pattern 331, and a second lead-out pattern 332 may be disposed on a lower surface of an insulating substrate 200, facing the sixth surface 106 of the body 100, and a second coil pattern 312, a first auxiliary lead-out pattern 341, and a second auxiliary lead-out pattern 342 may be disposed on an upper surface of the insulating substrate 200. The first and second lead-out patterns 331 and 332 of the second embodiment may be in contact with and connected to the external electrodes 400 and 500, respectively, in a similar manner to both end portions of the first and second coil patterns 311 and 312 of the above-described first embodiment.

Referring to FIGS. 8 and 10, on the lower surface of the insulating substrate 200, the first coil pattern 311 may be in contact with and connected to the first lead-out pattern 331, and each of the first coil pattern 311 and the first lead-out pattern 331 may be spaced apart from the second lead-out pattern 332. On the upper surface of the insulating substrate 200, the second coil pattern 312 may be in contact with and connected to the second auxiliary lead-out pattern 342, and each of the second coil pattern 312 and the second auxiliary lead-out pattern 342 may be spaced apart from the first auxiliary lead-out pattern 341. A first via 321 may pass through the insulating substrate 200 to respectively contact the first coil pattern 311 and the second coil pattern 312, a second via 322 may pass through the insulating substrate 200 to respectively contact the first lead-out pattern 331 and the first auxiliary lead-out pattern 341, and a third via 323 may pass through the insulating substrate 200 to respectively contact the second lead-out pattern 332 and the second auxiliary lead-out pattern 342. In this configuration, the coil portion 300 may function as a single coil which forms one or more turns around the core 110 as a whole.

The lead-out patterns 331 and 332, and the auxiliary lead-out patterns 341 and 342 may be exposed on the surfaces 101 and 102 of the body 100, respectively. For example, the first lead-out pattern 331 and the first auxiliary lead-out pattern 341 may be respectively exposed on the first surface 101 of the body 100, and the second lead-out pattern 332 and the second auxiliary lead-out pattern 342 may be respectively exposed on the second surface 102 of the body 100.

At least one of the coil patterns 311 and 312, the vias 321, 322, and 323, the lead-out patterns 331 and 332, and the auxiliary lead-out patterns 341 and 342 may include at least one conductive layer.

For example, when the second coil pattern 312, the auxiliary lead-out patterns 341 and 342, and the vias 321, 322, and 323 are formed on the other surface of the insulating substrate 200 by a plating process, each of the second coil pattern 312, the auxiliary lead-out patterns 341 and 342, and the vias 321, 322, and 323 may include a seed layer of electroless plating layers, or the like, and an electroplating layer. In this case, the electroplating layer may have a single-layer structure or a multilayer structure. The electroplating layer of the multilayer structure may be formed using a conformal film structure in which one electroplating layer is covered by another electroplating layer, and another electroplating layer is only stacked on one side of the one electroplating layer, or the like. The seed layer of the second coil pattern 312, the seed layers of the auxiliary lead-out patterns 341 and 342, and the seed layers of the vias 321, 322, and 323 may be integrally formed, and no boundary therebetween may occur, but are not limited thereto. The electroplating layer of the second coil pattern 312, the electroplating layers of the auxiliary lead-out patterns 341 and 342, and the electroplating layers of the vias 321, 322, and 323 may be integrally formed, and no boundary therebetween may occur, but are not limited thereto.

Based on FIGS. 8 and 11, the coil patterns 311 and 312, the lead-out patterns 331 and 332, and the auxiliary lead-out patterns 341 and 342 may be protruded from the lower surface and the upper surface of the insulating substrate 200, respectively. As another example, the first coil pattern 311, and the lead-out patterns 331 and 332 may be protruded from the lower surface of the insulating substrate 200, and the second coil pattern 312, and the auxiliary lead-out patterns 341 and 342 may be embedded in the upper surface of the insulating substrate 200, to expose each of the upper surfaces of the second coil pattern 312, and the auxiliary lead-out patterns 341 and 342 from the upper surface of the insulating substrate 200. In this case, since a recess may be formed in the upper surface of each of the upper surfaces of the second coil pattern 312, and/or the auxiliary lead-out patterns 341 and 342, each of the upper surfaces of the second coil pattern 312, and/or the auxiliary lead-out patterns 341 and 342, and the upper surface of the insulating substrate 200 may not be located on the same plane. As another example, the reverse of the other examples described above is also possible.

Each of the coil patterns 311 and 312, the lead-out patterns 331 and 332, the auxiliary lead-out patterns 341 and 342, and the vias 321, 322, and 323 may be formed of a conductive material such as copper (Cu), aluminum (Al), silver (Ag), tin (Sn), gold (Au), nickel (Ni), lead (Pb), titanium (Ti), or alloys thereof, but is not limited thereto.

Referring to FIG. 10, the first auxiliary lead-out pattern 341 may be independent of the electrical connection between the rest of the components of the coil portion 300, and thus may be omitted in the present disclosure. The first auxiliary lead-out pattern 341 may be formed to omit an operation of distinguishing the fifth surface 105 and the sixth surface 106 of the body 100 from each other.

Each of the first and second external electrodes 400 and 500 may include first and second pad portions 410 and 510 and first and second connection portions 420 and 520, arranged to be spaced from each other, on the sixth surface 106 of the body 100. In particular, the first external electrode 400 may include the first pad portion 410 formed on the sixth surface 106 of the body 100, and the first connection portion 420 passing through at least a portion of the body 100 to be connected to the first lead-out pattern 331 and the first pad portion 410, respectively. The second external electrode 500 may include the second pad portion 510 formed on the sixth surface 106 of the body 100, and the second connection portion 520 passing through at least a portion of the body 100 to be connected to the second lead-out pattern 332 and the second pad portion 510, respectively.

The first and second pad portions 410 and 510 may have a single-layer structure or a multilayer structure. For example, the first pad portion 410 may include a first layer comprising copper (Cu), a second layer disposed on the first layer and comprising nickel (Ni), and a third layer disposed on the second layer and comprising tin (Sn).

The first and second connection portions 420 and 520 may pass through at least a portion of the body 100. For example, in this embodiment, the first and second pad portions 410 and 510 may be connected to the first and second lead-out patterns 331 and 332 through the first and second connection portions 420 and 520 disposed in the body 100, instead of connecting the first and second external electrodes 400 and 500 to the first and second lead-out patterns 331 and 332 through the surface of the body 100.

Each of the first and second connection portions 420 and 520 may be extended from the coil portion 300. For example, after forming a plating resist having an opening on the first and second lead-out patterns 331 and 332, the first and second connection portions 420 and 520 may be plated and grown from the first and second lead-out patterns 331 and 332 through the opening of the plating resist. Alternatively, each of the first and second connection portions 420 and 520 may be formed by forming the body 100, processing a via hole on a side of the sixth surface of the body 100, and filling the via hole with a conductive material. In the former case, the first and second lead-out patterns 331 and 332 may function as a power supply layer when the first and second connection portions 420 and 520 are formed by an electrolytic plating process. As a result, a separate seed layer such as an electroless plating layer may not be formed at a boundary between the first and second connection portions 420 and 520 and the coil portion 300, but is not limited thereto. In the latter case, the first and second connection portions 420 and 520 may include a seed layer formed on the inner surface of the via hole, but is not limited thereto. For example, when the metal magnetic powder particle (P) has sufficient conductivity at plating current and voltage at the time of electroplating, a separate seed layer may not be formed even in the latter case.

FIG. 8 illustrates that each of the first and second connection portions 420 and 520 is formed as a single cylindrical shape, but it is merely for convenience of illustration and explanation. As another non-limiting example, one or more of the first connection portions 420 may be formed, and each of the first connection portions 420 may be formed in the form of a quadrangular column.

According to the present disclosure, the coil component may have low-profile and may improve saturation current, inductance, magnetic permeability, and core loss value.

While example embodiments have been shown and described above, it will be apparent to those skilled in the art that modifications and variations could be made without departing from the scope of the present disclosure as defined by the appended claims.

What is claimed is:

1. A coil component comprising:
a body having one surface and the other surface facing each other, and a plurality of wall surfaces connecting the one surface and the other surface, and having a distance from the one surface to the other surface of 0.65 mm or less (excluding 0 mm); and
a coil portion embedded in the body,
wherein the body comprises an Fe—Si—B—Nb—Cu-based metal magnetic powder particle represented by the following Chemical Formula 1,
wherein the Fe—Si—B—Nb—Cu-based metal magnetic powder particle comprises a crystal grain having a size of 20 nm or less (excluding 0 nm),
FeₐSi_{b}B_{c}Nb_{d}Cuₑ [Chemical Formula 1]
Where, in Chemical Formula 1, 73 atom %≤a≤77 atom %, 10 atom %≤b≤14 atom %, 9 atom %≤c≤11 atom %, 2 atom %≤d≤3 atom %, 0.5 atom %≤e≤1 atom %, and a+b+c+d+e=100.

2. The coil component according to claim 1, wherein the size of the crystal grain is 10 nm or more.

3. The coil component according to claim 1, wherein the Fe—Si—B—Nb—Cu-based metal magnetic powder particle has an average particle diameter of 10 μm to 50 μm, inclusive.

4. The coil component according to claim 1, wherein the Fe—Si—B—Nb—Cu-based metal magnetic powder particle has Wardell's sphericity (Ψ) of 0.8 or more and 1.0 or less.

5. The coil component according to claim 1, wherein the crystal grain comprises iron silicide (Fe₃Si).

6. The coil component according to claim 1, wherein both end portions of the coil portion are respectively exposed on surfaces, facing each other, of the plurality of wall surfaces of the body.

7. The coil component according to claim 6, further comprising first and second external electrodes respectively disposed on the surfaces of the plurality of wall surfaces of the body and respectively connected to the both end portions of the coil portion.

8. The coil component according to claim 1, further comprising an insulating substrate embedded in the body,
wherein the coil portion comprises first and second coil patterns respectively disposed on one surface and the other surface, facing each other, of the insulating substrate.

9. The coil component according to claim 8, wherein end portions of each of the first and second coil patterns are respectively exposed on surfaces, facing each other, of the plurality of wall surfaces of the body.

10. The coil component according to claim 9, further comprising first and second external electrodes respectively disposed on the surfaces of the plurality of wall surfaces of the body and respectively connected to the both end portions of the first and second coil patterns.

11. The coil component according to claim 10, wherein each of the first and second external electrodes comprises first and second pad portions disposed to be spaced apart from each other on the one surface of the body, and first and second connection portions passing through at least a portion of the body to respectively connect the first and second pad portions and the both end portions of the first and second coil patterns.

12. The coil component according to claim 8, wherein each of the first and second coil patterns comprises a first conductive layer formed on the insulating substrate, and a second conductive layer formed on the first conductive layer.

13. The coil component according to claim 12, wherein each of the first and second conductive layers comprises copper (Cu),
wherein a density of copper of the first conductive layer is lower than a density of copper of the second conductive layer.

14. A coil component comprising:
a body; a coil portion embedded in the body; and first and second external electrodes respectively formed on the body and respectively connected to both end portions of the coil portion,
wherein the coil component has a thickness of 0.65 mm or less (excluding 0 nm),
wherein the body comprises an Fe—Si—B—Nb—Cu-based metal magnetic powder particle represented by the following Chemical Formula 1,
wherein the Fe—Si—B—Nb—Cu-based metal magnetic powder particle comprises a crystal grain having a size of 20 nm or less (excluding 0 nm),
FeₐSi_{b}B_{c}Nb_{d}Cuₑ [Chemical Formula 1]
Where, in Chemical Formula 1, 73 atom %≤a≤77 atom %, 10 atom %≤b≤14 atom %, 9 atom %≤c≤11 atom %, 2 atom %≤d≤3 atom %, 0.5 atom %≤e≤1 atom %, and a+b+c+d+e=100.

15. The coil component according to claim 14, wherein an insulating coating layer is disposed on a surface of the Fe—Si—B—Nb—Cu-based metal magnetic powder particle.

16. The coil component according to claim 15, wherein the insulating coating layer comprises one or more selected from the group consisting of an epoxy resin and polyimide resin, and a liquid crystal polymer.

17. The coil component according to claim 1, wherein the body further comprises an insulating resin, and the Fe—Si—B—Nb—Cu-based metal magnetic powder particle is dispersed in the insulating resin.

18. A method of preparing a Fe—Si—B—Nb—Cu-based metal magnetic powder particle having a spherical shape comprising:
preparing a Fe—Si—B—Nb—Cu-based alloy material by mixing iron (Fe), silicon (Si), boron (B), niobium (Nb) and copper (Cu),
melting the Fe—Si—B—Nb—Cu-based alloy material by heating at a temperature of 1,250° C. or higher to produce a molten Fe—Si—B—Nb—Cu-based alloy material,
forming the Fe—Si—B—Nb—Cu-based metal magnetic powder particle having a spherical shape using a gas atomizing process by dropping the molten Fe—Si—B—Nb—Cu-based alloy material into water to forma droplet of the molten Fe—Si—B—Nb—Cu-based alloy material,
quenching to form the Fe—Si—B—Nb—Cu-based metal magnetic powder particle having a spherical shape, and
heating the Fe—Si—B—Nb—Cu-based metal magnetic powder particle having a spherical shape at a temperature of 520° C. to 560° C. for 30 to 90 min to form a crystal grain having a nanoscale size.

19. The method according to claim 18, wherein an insulating coating layer is disposed on a surface of the Fe—Si—B—Nb—Cu-based metal magnetic powder particle.

20. The method according to claim 19, wherein the insulating coating layer comprises one or more selected from the group consisting of an epoxy resin and polyimide resin.
